(19) United States
(12) Patent Application Publication
(10) Pub. No.: US 2026/0311057 A1
(43) Pub. Date: Oct. 8, 2026

(54) PARALLEL PROCESSING FOR MODEL EXECUTION

(71) Applicant: Apple Inc., Cupertino, CA (US)

(72) Inventor: Fernando A. MUJICA, Los Altos, CA (US)

(21) Appl. No.: 19/578,867

(22) Filed: Mar. 25, 2026

Related U.S. Application Data
(60) Provisional application No. 63/782,571, filed on Apr. 2, 2025.

(51) Int. Cl. G06N 20/00; G06N 5/04

(52) U.S. Cl. CPC G06N 20/00; G06N 5/04

(57) ABSTRACT

The subject technology provides for distributed training and inferencing of a machine learning model across multiple processing resources. During a forward pass, each processing resource generates a portion of an update for its corresponding portion of a feature set. While performing this computation, each resource can approximate, compress, and transmit its portion of the features to other resources, and can receive an approximated and compressed portion generated elsewhere. Each resource then decompresses the received representation and updates its local feature portion without waiting for full-precision data from other nodes. By allowing approximation, compression, communication, and computation to occur in parallel, the system may reduce communication overhead that typically causes idle compute periods. This structure may improve sustained utilization and responsiveness when models operate across multiple distributed compute nodes.

### CROSS-REFERENCE TO RELATED APPLICATIONS

The present application claims the benefit of U.S. Provisional Application No. 63/782,571, entitled “PARALLEL PROCESSING FOR MODEL EXECUTION”, filed Apr. 2, 2025, which is incorporated herein for reference in its entirety.

### TECHNICAL FIELD

This disclosure relates to machine learning, including, for example, training and/or inferencing of machine learning models using distributed computing systems.

### BACKGROUND

Machine learning is a field of artificial intelligence that enables systems to learn patterns and make data-driven decisions without explicit programming by leveraging algorithms and statistical models. Machine learning applications can be used in a variety of different domains including natural language processing, computer vision, healthcare, finance, etc.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system for training and/or inferencing a machine learning model according to aspects of the subject technology.

FIG. 3A illustrates an example of sharding of a set of adjustable features according to aspects of the subject technology.

FIG. 3B illustrates an example of sharding of a set of adjustable features according to aspects of the subject technology.

FIG. 4A illustrates an example of data flow between the processing resources where the weight matrix is sharded horizontally according to aspects of the subject technology.

FIG. 4B illustrates an example data flow between the processing resources where the weight matrix is sharded vertically according to aspects of the subject technology.

FIG. 5 illustrates an example of data compression performed by the processing resources according to aspects of the subject technology.

FIG. 6A illustrates an example of data compression and approximation performed by the processing resources according to aspects of the subject technology.

FIG. 6B illustrates the compression, decompression, and approximation performed by extended processing resources according to aspects of the subject technology.

FIG. 6C illustrates the compression, decompression, and approximation performed by extended processing resources at every compute node according to aspects of the subject technology.

FIGS. 6D-6G illustrate examples of matrix multiplication implementations for different compression and decompression function configurations according to aspects of the subject technology.

FIG. 7A illustrates the communication overhead between the processing resources according to aspects of the subject technology.

FIG. 7B illustrates the communication overhead between the processing resources according to aspects of the subject technology.

FIG. 7C illustrates the communication overhead between the processing resources according to aspects of the subject technology.

FIG. 8 illustrates an example of using Low Rank (LoRA) adapters according to aspects of the subject technology.

FIG. 9 illustrates an example of a transformer-based ML model with data compression and approximation performed by distributed processing resources according to aspects of the subject technology.

FIG. 10 illustrates a flowchart according to aspects of the subject technology.

FIG. 11 illustrates an example electronic system with which aspects of the subject technology may be implemented in accordance with one or more implementations.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

Machine learning (ML) is a field of artificial intelligence (AI) that enables systems to learn patterns and make data-driven decisions without explicit programming. ML models can be used in a variety of different domains including natural language processing (NLP), computer vision, healthcare, finance, etc. Central to this field is the training and/or inferencing of ML models using large data sets to learn complex data patterns and inferencing the ML models to generate predictions. As datasets grow larger and the ML models become more complex, training and/or inferencing of ML models on a single processing resource becomes computationally expensive and time consuming. As ML models become larger, the cost and runtime to perform inference (running the model) increases significantly.

To mitigate the issue, training and/or inferencing of ML models can be done by splitting the workload across multiple processing resources, significantly accelerating the respective processes. Distributed training and/or inferencing may involve parallelizing data processing across computing clusters, GPUs, or cloud environments. However, running ML models on multiple processing resources may result in a communication overhead that arises from the need to synchronize data between the multiple processing resources. Since each processing resource involved in training and/or inference a ML model may need to share and aggregate large amounts of intermediate results, there may be delays resulting from the transmission of data over a physical transport medium, such as a bus, a network, and the like. Additional delays can be introduced if one or more processing resources take longer to compute the intermediate results.

To address these delays and to reduce the overall training and/or inference time of ML models across multiple processing resources, each processing resource may approximate and compress their portion of data before transmitting the approximated and compressed data to other processing resources. This approximation and compression can reduce the required network bandwidth and the time required for data transfer. Additionally, the processing resources can begin transmitting the approximated and compressed data before generating the outputs such as intermediate results required by the other processing resources training and/or inferencing the ML models. The processing resources receiving the approximated and compressed data can reconstruct the output of the processing resources transmitting the approximated and compressed data, allowing computation and communication to overlap. This approach minimizes transmission latency by leveraging the computation time to mask the time required for data transfer.

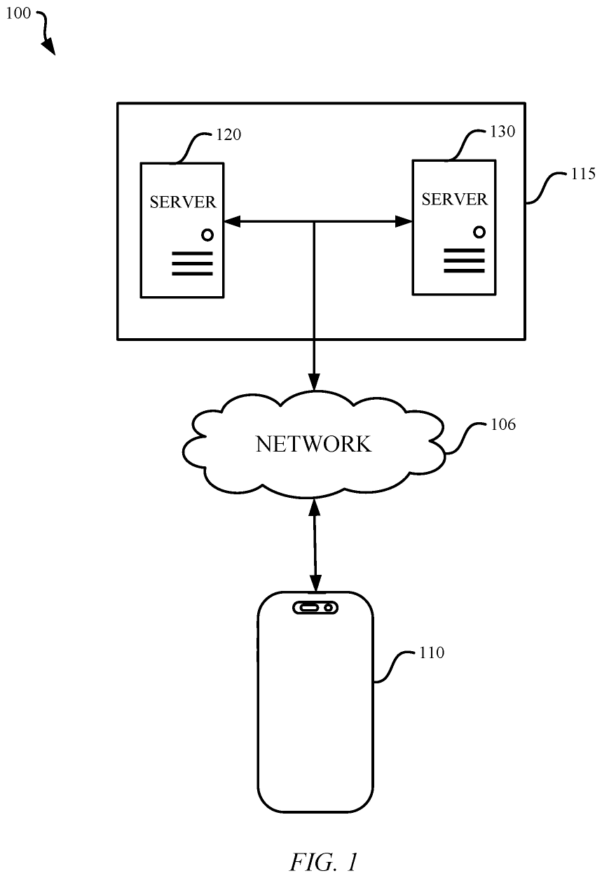

FIG. 1 illustrates an example network environment 100 in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes a user device 110 and a computing cluster 115. A computing cluster can include two or more processing resources, typically servers connected using high speed local area network (LAN) for supporting large-scale processing. In this example, the computing cluster 115 includes a server 120 (also referred to as a first processing resource) and a server 130 (also referred to as a second processing resource). Each of the servers 120 and 130 may individually include multiple different processing resources, such as one or more central processing units (CPUs), one or more graphics processing units (GPUs), and/or one or more specialized machine learning (or neural) processors which may be interconnected via a bus and/or other fabric or interconnect. For explanatory purposes, the subject system is generally described herein with reference to the server 120 and the server 130; however, it will be understood that the subject system may also be implemented by separate and/or distinct computing and/or processing resources within one of the servers 120 or 130 and/or by separate and/or distinct computing and/or processing resources within a semiconductor device (e.g., a system-on-a-chip) within one of the servers 120 or 130.

The network 106 may communicatively (directly or indirectly) couple the user device 110 and the processing resources of the computing cluster 115. In one or more implementations, the network 106 may be an interconnected network of devices that may include, or may be communicatively coupled to, the Internet. For explanatory purposes, the network environment 100 is illustrated in FIG. 1 using the user device 110 and the computing cluster 115 which includes the server 120, and the server 130; however, the network environment 100 may include any number of electronic devices, computing clusters, and servers.

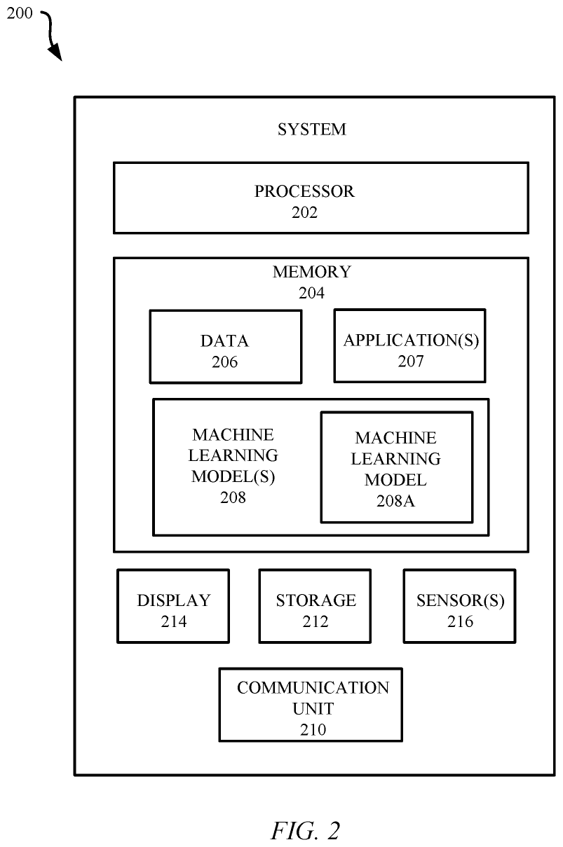

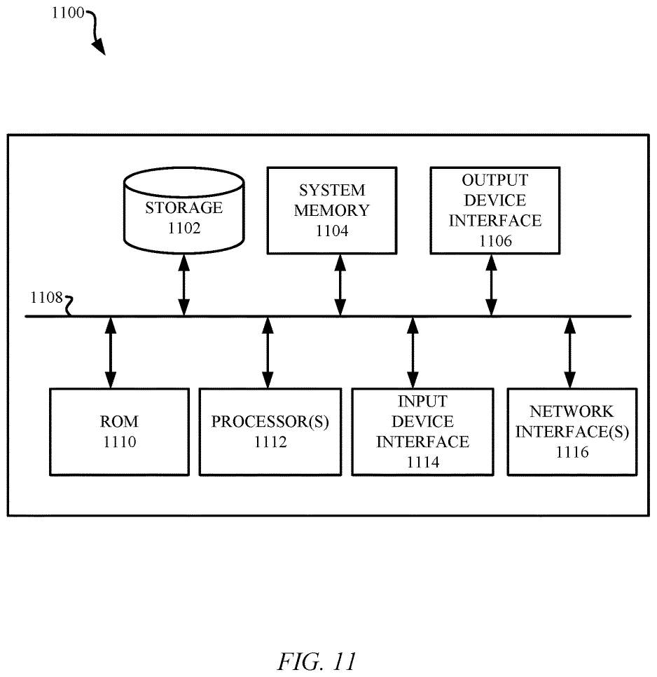

The user device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the user device 110 is depicted as a smartphone. However, the user device 110 may be an electronic device (e.g., a smartphone, a tablet device, a laptop computer, a desktop computer, a wearable electronic device, etc.) that can be used for entertainment or to communicate with entities like friends, family, colleagues, etc. The user device 110 may be, and/or may include all or part of, the systems discussed below with respect to FIG. 2 and/or FIG. 11.

In some implementations, the computing cluster 115 can use the server 120 and the server 130 for training and/or inferencing of ML models. The ML models deployed on the user device 110 may then perform one or more machine learning tasks. In some implementations, the server 120 and the server 130 may train and provide a cloud service that utilizes the trained machine learning model and is continually refined over time. The server 120 and the server 130 may be, and/or may include all or part of, the systems discussed below with respect to FIG. 2 and/or with respect to FIG. 11.

FIG. 2 illustrates an example system 200 of the computing cluster 115 for training and/or inferencing a ML model in accordance with some implementations of the subject technology. In an example, the system 200 may be implemented in the computing cluster 115 (e.g., the server 120 and the server 130). The system 200 can also be implemented using processing resources located in different geographical regions.

In an example, the servers (e.g., the server 120 and the server 130) can include a processor 202, memory 204 (memory device) and a communication unit 210. The memory 204 may store data 206 and one or more ML models 208A. In an example, the server may be communicatively coupled with a storage 212. Thus, the storage 212 may be either an internal storage or an external storage. In the example of FIG. 2, the server may include a display 214, and one or more sensors(s) 216. Sensor(s) 216 may include location sensors (e.g., satellite positioning system sensors), motion sensors (e.g., inertial sensors), and/or temperature monitoring sensors.

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or inferencing machine learning models, such as large language models, state machines, logic circuitries, and/or any devices that manipulate signals based on operational instructions. Among other capabilities, the processor 202 is configured to fetch and execute computer-readable instructions and data stored in the memory 204.

In an example, the communication unit 210 of the servers may include one or more hardware units that support wired or wireless communication between the processor 202 and processors of other processing clusters using the LAN.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory may include one or more applications 207 that are currently being executed on the servers. In an example, the one or more applications can be executed in a distributed setting wherein the execution of the one or more applications is performed in part by the server 120 and the server 130. The one or more applications 207 can interact with each other or with an operating system of the server 120 and the server 130 using application programming interfaces (API) to send or receive data.

The data 206 may represent, amongst other things, a repository of data processed, received, and generated by one or more processors such as the processor 202 of the servers. One or more of the aforementioned components of the servers may send or receive data, for example, using one or more input/output ports and one or more communication units.

The machine learning (ML) models 208 may include one or more ML models. In an example, the machine learning model(s) 208 may be trained using training data (e.g., included in the data 206 or other data) and may be implemented by the processor 202 of the servers for performing one or more of the operations, as described herein.

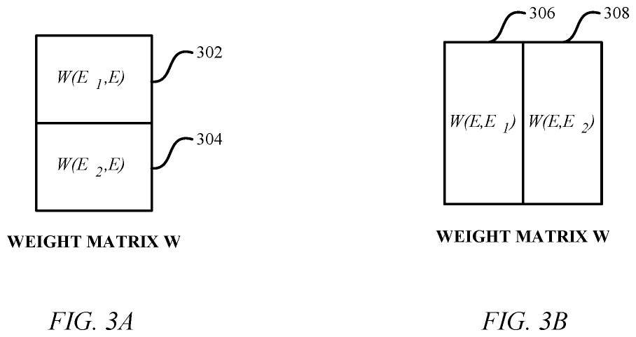

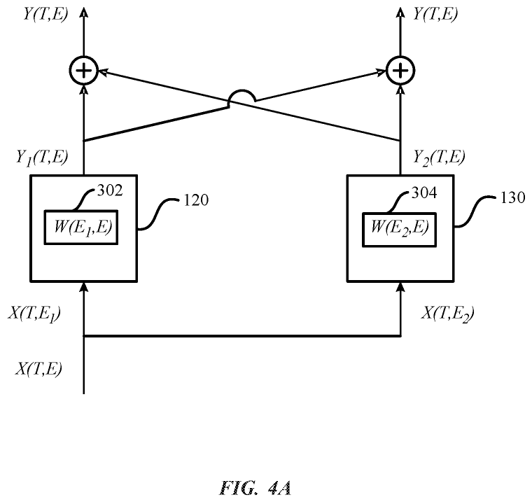

In some implementations, the system 200 can train and/or inference a ML model such as a ML model 208A using the server 120 and the server 130. The training and/or inferencing of the ML model 208A can include a forward pass of the ML model 208A where the input data is processed to generate predictions. During training, to perform the forward pass, the system 200 processes a set of input features through the layers of the ML model 208A, applying transformations using the set of adjustable weights and producing an output prediction. The system 200 then compares the prediction to the actual target values to compute an error (Loss). This error is subsequently used in the backward pass of the ML model 208A to adjust the set of adjustable weights of the ML model using optimization algorithms such as stochastic gradient descent (SGD) or Adam thereby improving the accuracy of the ML model 208A over multiple iterations. During inference, the system 200 performs the forward pass, but without performing any updates to the set of adjustable weights. The system 200 uses the ML model 208A to process a set of input features using the set of adjustable weights to generate a prediction. To execute the ML model 208A, the system 200 implemented on the server 120 and the server 130 can share the ML model 208A between the server 120 and the server 130 by sharding the set of adjustable weights of the ML model 208A between the server 120 and the server 130. The sharding of the set of adjustable weights of the ML model 208A is described with reference to FIG. 3A and FIG. 3B.

FIG. 3A and FIG. 3B illustrate the sharding of the set of adjustable weights of a ML model between the multiple processing resources. As described above, the ML model 208A includes a set of adjustable weights. In general, the set of adjustable weights of the ML model 208A are represented using a matrix for a compact and scalable representation of the connections between the neurons of each layer of the ML model 208A and allowing the use of matrix multiplication to process multiple inputs and compute outputs simultaneously. For example, in a neural network layer with n input neurons and m output neurons, the set of adjustable weights can be represented as a weight matrix W having dimensions n×m, where each element of the weight matrix W represents a weight of the connection between specific input neuron and output neuron.

In some implementations, the system 200 can generate multiple portions of the set of adjustable weights by sharding the weight matrix W such that each processing resource for the ML model 208A can store and process a portion of the set of adjustable weights. In this example, the system 200 generates two portions of the set of adjustable weights referred to as the first portion and the second portion such that the first portion is stored in the first processing resource i.e., the server 120 and the second portion is stored in the second processing resource i.e., the server 130. FIG. 3A illustrates the set of adjustable weights (represented as the weight matrix W,) the first portion of the set of adjustable weights 302 and the second portion of the set of adjustable weights 304. FIG. 3A also illustrates a sharding technique where the weight matrix W is sharded horizontally. For example, if the weight matrix W has dimensions E rows×E columns, and the sharding is performed equally between two compute resources, the first portion of the set of adjustable weights can include rows 1 to E/2 and the second portion of the set of adjustable weights can include rows E/2+1 to E. For brevity, the first portion of the set of adjustable weights 302 are represented using W(E₁, E) and the second portion of adjustable weights 304 are referred to as W(E₂, E). As described earlier, the server 120 stores the first portion of the set of adjustable weights in the form of a matrix W(E₁, E) and the server 130 stores the second portion of set of adjustable weights in the form of a matrix W(E₂, E). Though the techniques and methods has been described with reference to two processing resources the server 120 and the server 130, any number of processing resources can be used for training and/or inferencing the ML model 208A.

FIG. 3B illustrates another sharding technique where the weight matrix W is sharded vertically. For example, if the weight matrix W has dimensions E rows×E columns, and the sharding is performed equally between two compute resources, the first portion of the set of adjustable weights can include columns 1 to E/2 and the second portion of the set of adjustable weights can include columns E/2+1 to E. Following the similar naming convention explained with reference to FIG. 3A, the first portion of the set of adjustable weights 306 can be represented using W(E, E₁) and the second portion of adjustable weights 308 can be represented using W(E, E₂). In this example, the server 120 stores the first portion of the set of adjustable weights in the form of a matrix W(E, E₁) and the server 130 stores the second portion of the set of adjustable weights in the form of a matrix W(E, E₂). Although the inferencing and training techniques of the ML model 208A are described in connection to the sharding technique of FIG. 3A (e.g., horizontal sharding), the inferencing and training techniques of the ML model 208A can also be implemented using the sharding technique of FIG. 3B (e.g., vertical sharding).

In some embodiments, the system 200 can select a data sample to generate a set of features by transforming raw input data of the sample into numerical or structured representations for the ML model 208A. For example, if the ML model 208A is to be trained for language-to-language translation, the ML model 208A can generate a set of features from the input sentence by processing the input sentence and using multiple layers of self-attention and feed forward networks. For example, if the input sentence is “I am John Doe.” the ML model 208A can generate an embedded representation of the input sentence and map the embedded representation to a set of features that is generally represented as a dense vector. The set of features can be represented as a feature matrix X having dimensions T rows×E columns.

While performing a forward pass on the ML model 208A, the system 200 can process the set of adjustable weights and the set of features for a current layer of the ML model 208A to generate a set of features for a subsequent layers of the ML model 208A. To generate the set of features for a subsequent layer, the system 200 can perform a matrix multiplication of the weight matrix W of the current layer and the feature matrix X to generate new values for the set of features for the subsequent layer and updates the set of features X of the current layer by the new values of the set of features for the subsequent layer.

In some implementations, the system 200 can perform matrix multiplications to perform the transformations needed to process data samples. The matrix multiplication can be expressed as

$$Y ( T , E ) = X ( T , E ) W ( E , E )$$

where Y(T,E) represents the set of features for the subsequent layer of the ML model 208A.

However, since the first portion of the set of adjustable weights is processed using the server 120 and the second set of adjustable weights is processed using the server 130, the set of features for the subsequent layer of the ML model 208A is partly computed using the server 120 and partly computed using the server 130. This is further described in detail below.

In some embodiments, the system 200 can process the set of adjustable weights and the set of features using the server 120 and the server 130. Processing the set of adjustable weights and the set of features involves multiplying the weight matrix Wand the feature matrix X. In this example, the matrix multiplication can be represented as

$$Y ( T , E ) = X ( T , E ) W ( E , E ) = {Y}_{1} ( T , E ) + {Y}_{2} ( T , E ) = X ( T , {E}_{1} ) W ( {E}_{1} , E ) + X ( T , {E}_{2} ) W ( {E}_{2} , E )$$

where Y(T,E) is the set of features for the subsequent layer of the ML model 208A, Y₁(T, E) is the first portion of the update for the set of features generated by the server 120 and Y₂(T, E) is the second portion of the updates for the set of features generated by the server 130. After generating the respective updates for the set of features, the server 120 and the server 130 can transmit their respective updates to each other.

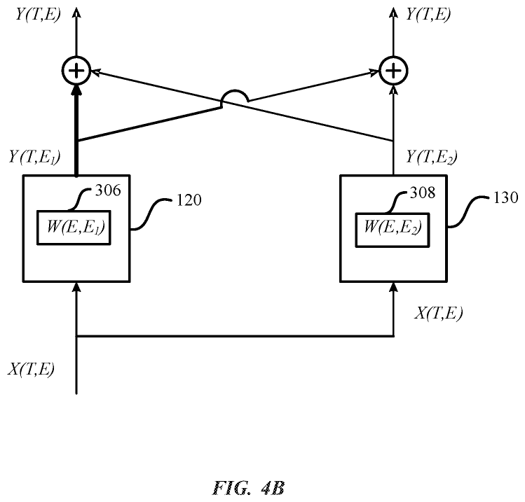

FIG. 4A illustrates the data flow between the processing resources where the weight matrix Wis sharded horizontally while performing a forward pass on the ML model 208A. As seen in FIG. 4A, the first portion of the set of adjustable weights 302 represented as W(E₁, E) is stored in the server 120 and the second portion of the set of adjustable weights 304 represented as W(E₂, E) is stored in the server 130.

Assuming that the weights W(E₁, E) and the weights W(E₂, E) are associated with the first layer of the ML model 208A and the set of features X is provided as input to the server 120, the server 120 generates the first portion of the set of features X(T, E₁) and the second portion of the set of features X(T, E₂) by sharding the feature matrix X along the column dimension. In some embodiments, the server 120 retains the first portion of the set of features X(T, E₁) and transmits the second portion of the set of features X(T, E₂) to the server 130. If the weights W(E₁, E) and the weights W(E₂, E) are associated with any other layer of the ML model 208A, the server 120 can skip the generation of the first portion of the set of features X(T, E₁) and the second portion of the set of features X(T, E₂) and proceed with the following operations.

As described above, the server 120 performs a matrix multiplication using the first portion of the set of adjustable weights 302 (e.g., W(E₁,E)) and the first portion of the set of features X(T, E₁) to generate the first portion of the update for the set of features for the subsequent layer Y₁(T, E). Similarly, after receiving the second portion of the set of features X(T, E₂) from the server 120, the server 130 performs a matrix multiplication using the second portion of the set of adjustable weights 304 (e.g., W (E₂, E)) and the second portion of the set of features X(T, E₂) to generate the second portion of the update for the set of features for the subsequent layer Y₂(T, E). The matrix multiplication performed by the server 120 and the server 130 can be represented as Y₁(T, E)=X(T, E₁)W(E₁, E) and Y₂(T, E)=X(T, E₂)W(E₂, E) respectively. Note that Y₁(T, E) and Y₂(T, E) can be combined to generate the set of features for a subsequent layer of the ML model 208A.

The server 120 can compute the full update for the set of features for the subsequent layer of the ML model 208A by transmitting the first portion of the update for the set of features Y₁(T, E) to the server 130 and by receiving the second portion of the update for the set of features Y₂(T, E) from the server 130. For example, as seen in FIG. 4A, the server 120 transmits Y₁(T, E) to the server 130 and the server 130 transmits Y₂(T, E) to the server 120. After receiving the second portion of the update for the set of features Y₂(T, E) from the server 130, the server 120 performs a matrix addition to compute the full update for the set of features. Similarly, after receiving the first portion of the update for the set of features for the subsequent layer Y₁(T, E) from the server 120, the server 130 performs a matrix addition to compute the full update for the set of features. The matrix addition performed by the server 120 and the server 130 can be represented as Y(T, E)=Y₁(T, E)+Y₂(T, E). Note that the transmission of Y₁(T, E) and Y₂(T, E) by the server 120 and the server 130 respectively, causes communication overhead since the server 120 and the server 130 have to wait for Y₂(T, E) and Y₁(T, E) respectively.

FIG. 4B illustrates the data flow between the processing resources where the weight matrix Wis sharded vertically while performing a forward pass on the ML model 208A. As seen in FIG. 4B, the first portion of the set of adjustable weights 306 represented as W(E, E₁) is stored in the server 120 and the second portion of the set of adjustable weights 308 represented as W(E, E₂) is stored in the server 130.

Assuming that the weights W(E, E₁) and the weights W(E, E₂) are associated with the first layer of the ML model 208A and the set of features X is provided as input to the server 120 and to the server 130.

As described above, the server 120 performs a matrix multiplication using the first portion of the set of adjustable weights W(E, E₁) and the set of features X(T, E) to generate the first portion of the update for the set of features for the subsequent layer Y(T, E₁). Similarly, the server 130 performs a matrix multiplication using the second portion of the set of adjustable weights W (E,) and the set of features X(T, E) to generate the second portion of the update for the set of features for the subsequent layer Y(T, E₂). The matrix multiplication performed by the server 120 and the server 130 can be represented as Y(T, E₁)=X(T, E)W(E, E₁) and Y(T, E₂)=X(T, E)W(E, E₂) respectively. Note that Y(T, E₁) and Y(T, E₂) can be combined to generate the set of features for a subsequent layer of the ML model 208A.

The server 120 can compute the full update for the set of features for the subsequent layer of the ML model 208A by transmitting the first portion of the update for the set of features Y(T, E₁) to the server 130 and by receiving the second portion of the update for the set of features Y(T, E₂) from the server 130. For example, as seen in FIG. 4B, the server 120 transmits Y(T, E₁) to the server 130 and the server 130 transmits Y(T, E₂) to the server 120. After receiving the second portion of the update for the set of features Y(T, E₂) from the server 130, the server 120 performs a matrix addition to compute the full update for the set of features. Similarly, after receiving the first portion of the update for the set of features for the subsequent layer Y(T, E₁) from the server 120, the server 130 performs a matrix addition to compute the full update for the set of features. The matrix addition performed by the server 120 and the server 130 can be represented as Y(T, E)=Y(T, E₁)+Y(T, E₂). Note that the transmission of Y(T, E₁) and Y(T, E₂) by the server 120 and the server 130 respectively, causes communication overhead since the server 120 and the server 130 have to wait for Y(T, E₂) and Y(T, E₁) respectively.

The communication overhead can introduce periods during which compute resources remain idle while awaiting data exchange between compute nodes. In one or more implementations, similar effects can occur in practical distributed systems that do not provide sufficiently low-latency or high-bandwidth interconnects. Mitigating this communication overhead can relax interconnect latency and bandwidth constraints. Such changes may beneficially increase sustained utilization, improve responsiveness, and lower overall system cost by allowing compute nodes to perform useful work rather than waiting for intermediate data transfers.

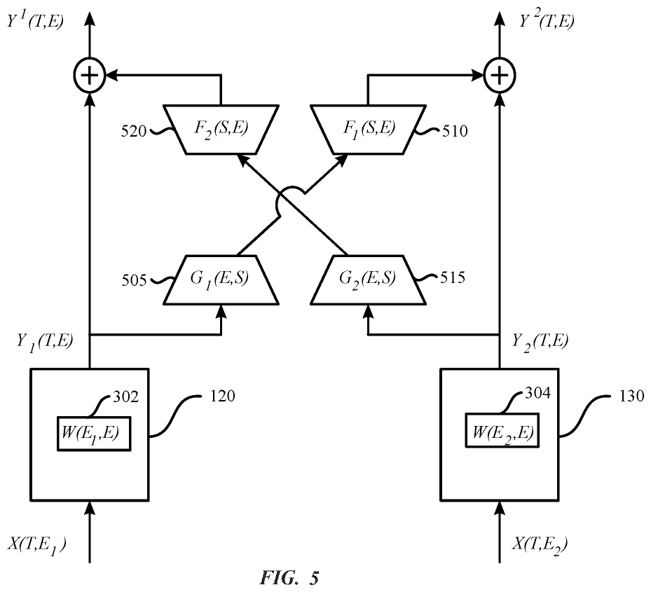

In some embodiments, the system 200 can be configured to reduce the amount of data transmitted by the processing resources to generate the update for the set of features for the subsequent layer Y(T,E). In such embodiments, the processing resources can compress their respective portions of the updates prior to transmitting to one or more other processing resources. This is further explained with reference to FIG. 5.

FIG. 5 illustrates the data transmission performed by the processing resources while inferencing the ML model 208A. As seen in FIG. 5, the server 120 performs a matrix multiplication using the first portion of the set of adjustable weights 302 and the first portion of the set of features to generate the first portion of the update for the set of features for the subsequent layer Y₁ (T, E). Similarly, server 130 performs a matrix multiplication using the second portion of the set of adjustable weights 304 and the second portion of the set of features to generate the second portion of the update for the set of features for the subsequent layer Y₂(T, E).

In some embodiments, prior to transmitting the first portion of the update for the set of features for the subsequent layer Y₁(T, E), the server 120 can use an adapter such as a neural network adapter to compress the first portion of the update. In some embodiments, the neural adapter is a specialized neural network architecture designed to efficiently compress data by representing the data in a more compact form while minimizing information loss. For example, the server 120 uses a compression adapter 505 to compress Y₁(T, E) to generate a compressed representation of Y₁(T, E). Subsequently, the server 120 can transmit the compressed representation of Y₁(T, E) to the server 130. Similarly, the server 130 uses the compression adapter 515 to compress Y₂(T, E) to generate a compressed representation of Y₂(T, E). The server 130 can then transmit the compressed representation of Y₂(T, E) to the server 120.

In some embodiments, after receiving the compressed representation of Y₂(T, E) from the server 130, the server 120 can use a decompression adapter 520 to decompress the compressed representation of Y₂(T, E). After decompressing, the server 120 can use the decompressed representation of Y₂(T, E) to generate the first portion of the updated set of features Y¹(T, E) for the subsequent layer of the ML model 208A. Note that the decompressed representation of Y₂(T, E) is the second portion of the update for the set of features for the subsequent layer Y₂ (T, E). In some embodiments, the compression and decompression of Y₂(T, E) can be lossless. In other embodiments, the compression and decompression techniques can be lossy such that the decompressed representation of Y₂(T, E) approximates the second portion of the update for the set of features for the subsequent layer Y₂(T, E) that is generated by the server 130. The compression and decompression of the second portion of the updates for the set of features Y₂(T, E) can be represented as

$${Y}^{1} ( T , E ) = X ( T , {E}_{1} ) W ( {E}_{1} , E ) + X ( T , {E}_{2} ) W ( {E}_{2} , E ) {G}_{2} ( E , S ) {F}_{2} ( S , E )$$

where G₂(E,S) represents the compression performed by the compression adapter 515 and F₂(S, E) represents the decompression performed by the decompression adapter 520.

Similarly, after receiving the compressed representation of Y₁(T, E) from the server 120, the server 130 can use a decompression adapter 510 to decompress the compressed representation of Y₁(T, E). After decompressing, the server 130 can use the decompressed representation of Y₁(T, E) to generate the updated set of features Y¹(T, E) for the subsequent layer of the ML model 208A. Note that the decompressed representation of Y₁(T, E) is the first portion of the update for the set of features for the subsequent layer Y₁(T,E). As described above, the compression and decompression of the first portion Y₁(T, E) can be lossy or lossless. The compression and decompression of the first portion of the updates for set of features Y₁ (T, E) can be represented as

$${Y}^{2} ( T , E ) = X ( T , {E}_{2} ) W ( {E}_{2} , E ) + X ( T , {E}_{1} ) W ( {E}_{1} , E ) {G}_{1} ( E , S ) {F}_{1} ( S , E )$$

where G₁(E,S) represents the compression performed by the compression adapter 505 and F₁(S, E) represents the decompression performed by the decompression adapter 520. It should be noted that if the compression and decompression techniques are lossless, the Y¹(T, E) and Y²(T, E) are identical. It should be noted that transmitting the portion of updates without compressing causes network delay and uses more network bandwidth. In comparison, compressing the portion of updates prior to transmission to other computing resources minimizes network latency and uses less network bandwidth.

In some embodiments, the compression adapter 505 and the decompression adapter 510 can be an autoencoder trained to minimize the reconstruction error during compression and decompression. Similarly, the compression adapter 515 and the decompression adapter 520 can be an autoencoder which is also trained to minimize the reconstruction error during compression and decompression. Though the example has been explained using compression adapter and decompression adapters, any compression and decompression technique can be used such as principal component analysis (PCA), discrete cosine transform (DCT), quantization techniques such as K-means quantization, etc.

In some embodiments, the system 200 can be further optimized so that the processing resources can approximate the portions of the updates for the set of features from the portions of the set of features associated with other processing resources. For example, while the server 120 is processing the first portion of the set of adjustable weights W(E₁, E) and the first portion of the set of features X(T, E₁) to generate Y₁(T, E), the server 120 can transmit the first portion of the set of features X(T, E₁) to the server 130. Similarly, while the server 130 is processing the second portion of the set of adjustable weights W(E₂, E) and the second portion of the set of features X(T, E₂) to generate Y₂(T, E), the server 130 can transmit the second portion of the set of features X(T, E₂) to the server 120. The server 120 can use second portion of the set of features X(T, E₂) to generate an approximation of Y₂(T, E) and subsequently generate Y¹(T, E). Similarly, server 130 can use first portion of the set of features X(T, E₁) to generate an approximation of Y₁(T, E) and subsequently generate Y²(T, E). In such embodiments, the system 200 may reduce the total time needed to compute the updated set of features for the subsequent layer of the ML model 208A by transmitting the portions of the set of features and by approximating the portions of updates for the set of features computed by other processing resources while each of the processing resource is computing their respective portion of the updates thereby masking the time required for data transfer using the processing times of the processing resources for generating their respective portion of their updates.

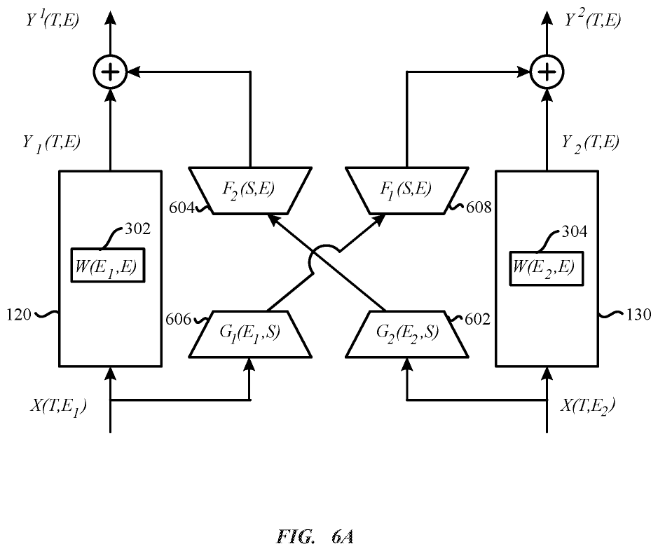

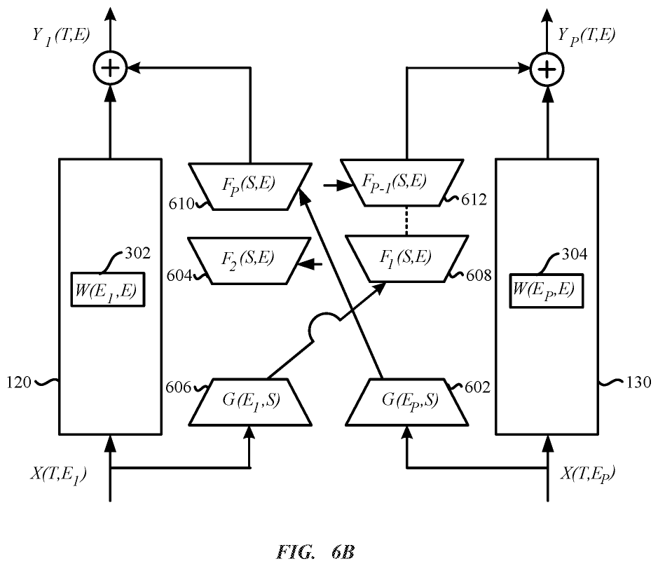

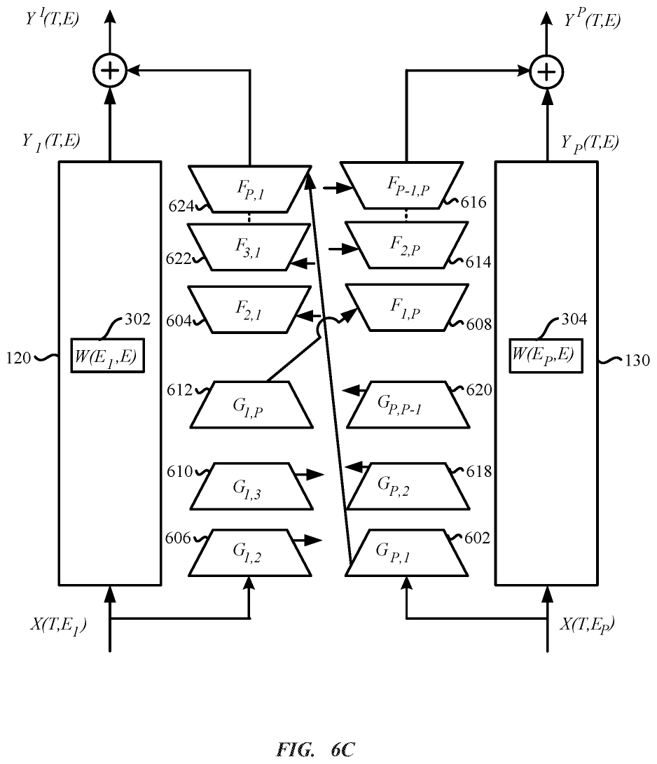

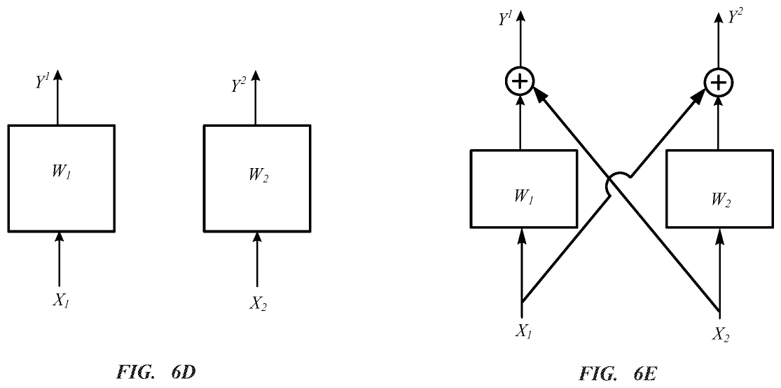

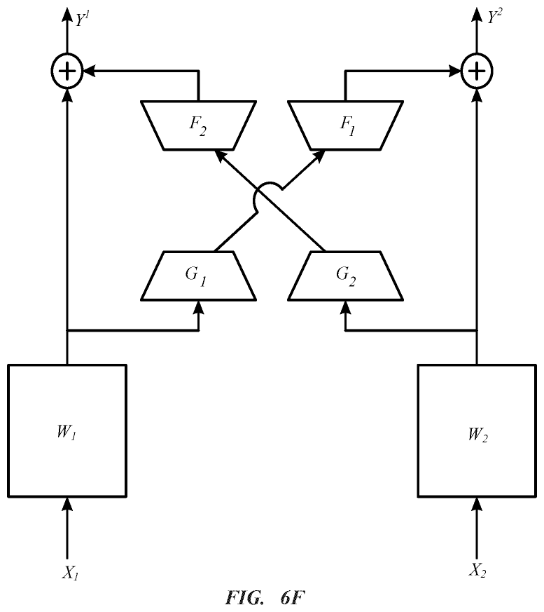

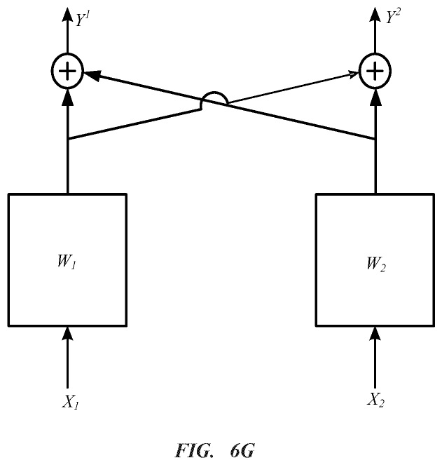

In some embodiments, the computing resources can further compress the portions of the set of features prior to transmitting the portions of the set of features to other computing resources thereby reducing the network bandwidth required by the system 200 for the data transfer. For example, the server 120 can compress the first portion of the set of features X(T,E₁) and transmit the compressed representation of X(T,E₁) to the server 130 while simultaneously processing the first portion of the set of adjustable weights W (E₁, E) and the first portion of the set of features X(T,E₁) to generate Y₁(T,E). The server 130 can decompress the compressed representation of X(T, E₁) to generate an approximation of Y₁(T,E) and subsequently generate Y²(T, E). Similarly, the server 130 can compress X(T, E₂) and transmit the compressed representation of X(T, E₂) to the server 120 while simultaneously processing the second portion of the set of adjustable weights W (E₂, E) and the second portion of the features X(T, E₂) to generate Y₂(T, E). The server 120 can decompress the compressed representation of X(T, E₂) to generate an approximation of Y₂(T, E) and subsequently generate Y¹(T, E). In some embodiments, the compression, decompression, and approximation can be performed using an adapter such as a neural network adapter. This is further explained with reference to FIG. 6.

FIG. 6A illustrates the compression, decompression, and approximation performed by the processing resources for inferencing the ML model 208A. As seen in FIG. 6A, the server 120 compresses the first portion of the set of features X(T, E₁) using a compression adapter 606 represented as G₁(E₁, S) and transmits the compressed representation of X(T, E₁) to the server 130 while simultaneously processing the first portion of the set of adjustable weights 302 represented as W(E₁, E) and the first portion of the set of features X(T, E₁) to generate the first portion of the updates for the set of features for the subsequent layer Y₁(T, E). The server 130 decompresses the compressed representation of X(T, E₁) using a decompression adapter 608 represented as F₁(S, E) to generate an approximation of Y₁(T, E) and subsequently generates Y²(T, E). Similarly, the server 130 compresses the second portion of the set of features X(T, E₂) using a compression adapter 602 represented as G₂(E₂,S) and transmits the compressed representation of X(T, E₂) to the server 120 while simultaneously processing the second portion of the set of adjustable weights 304 represented as W(E₂, E) and the second portion of the features X(T, E₂) to generate the second portion of the updates for the set of features Y₂(T, E). The server 120 decompresses the compressed representation of X(T, E₂) using a decompression adapter 604 represented as F₂(S, E) to generate an approximation of Y₂(T, E) and subsequently generate Y¹(T, E).

In one or more implementations, computation of the function Gᵢ, transmission of the compressed data, and computation of the function Fᵢ can occur in parallel with the computation associated with W(Eᵢ, E). This parallel activity may beneficially reduce timing dependencies between compute stages. When these operations overlap in time, the communication overhead associated with exchanging intermediate data between distributed compute resources can be mitigated to the point that data-exchange delays may no longer impact the execution timeline.

The approximated system can be represented using equations that relate the system inputs to the generated outputs, which may be represented as follows:

$${Y}^{1} ( T , E ) = X ( T , {E}_{1} ) W ( {E}_{1} , E ) + X ( T , {E}_{2} ) G ( {E}_{2} , S ) {F}_{2} ( S , E )$$

$${Y}^{2} ( T , E ) = X ( T , {E}_{2} ) W ( {E}_{2} , E ) + X ( T , {E}_{1} ) G ( {E}_{1} , S ) {F}_{1} ( S , E ) .$$

These equations may characterize how the approximation functions and the primary matrix multiplication path interact during distributed execution while maintaining compatibility with the broader system architecture.

In one or more implementations, the system 200 can be represented by the approximated system when G=W (with the understanding that the dimensions of G may differ from those of W) and Fᵢ=1. Under these conditions, the approximation path may behave in a manner that functionally aligns with the unmodified matrix multiplication path.

The compressed system can be viewed as a subset of the approximated system when G(Eᵢ,S)=W(Eᵢ, E) G(Eᵢ,S) and Fᵢ=Fᵢ′. This relationship may indicate that the approximation framework provides a generalized structure from which compression-oriented configurations can be obtained without altering the broader computational flow.

In one or more implementations, the outputs generated by the compressed and approximated representations do not match each other and do not match the output produced by the original system, expressed as Y¹(T, E)=Y²(T, E)=Y(T, E). These differences can arise from the reduced-dimensional transformations and approximation functions used in the compressed and approximated paths, which may introduce deviations from the full-precision output while allowing beneficial reductions in communication activity across distributed compute resources.

Note that the operations of compression and decompression performed by the compression adapter 602 and decompression adapter 604 also includes approximation of Y₂(T, E). Similarly, the operations of compression and decompression performed by the compression adapter 606 and decompression adapter 608 also includes approximation of Y₁(T,E). In some embodiments, the compression adapter 606 and the decompression adapter 608 can be an autoencoder trained to minimize the reconstruction error while generating an approximation of Y₁(T, E). Similarly, the compression adapter 602 and the decompression adapter 604 can be an autoencoder which is trained to minimize the reconstruction error while generating an approximation of Y₂(T, E). Though this example has been explained using compression adapter and decompression adapters, any compression and decompression technique can be used such as principal component analysis (PCA), discrete cosine transform (DCT), quantization techniques such as K-means quantization, or the like.

FIG. 6B illustrates the compression, decompression, and approximation performed by P processing resources for inferencing the ML model 208A. As seen in FIG. 6B, the server 120 compresses the first portion of the set of features X(T, E₁) using a compression adapter 606 represented as G(E₁, S) and transmits the compressed representation of X(T, E₁) to the server 130 while simultaneously processing the first portion of the set of adjustable weights 302 represented as W(E₁, E) and the first portion of the set of features X(T, E₁) to generate the first portion of the updates for the set of features for the subsequent layer Y₁(T, E). The server 130 decompresses the compressed representation of X(T, E₁) across a decompression adapter 608 represented as F₁(S, E), similarly the server 130 decompresses the compressed representation of X(T, E_{P-1}) across decompression adapter 612 represented as F_{P-1}(S, E), and likewise for the other compressed data received from the other servers, to generate an approximation of Y₁(T, E) and subsequently generates Y^{P}(T, E). Similarly, the server 130 compresses the second portion of the set of features X(T, E_{P}) using a compression adapter 602 represented as G(Er, S) and transmits the compressed representation of X(T, E_{P}) to the server 120 while simultaneously processing the second portion of the set of adjustable weights 304 represented as W(E_{P}, E) and the second portion of the features X(T, E_{P}) to generate the second portion of the updates for the set of features Y_{P}(T, E). The server 120 decompresses the compressed representation of X(T, E₂) simultaneously across a decompression adapter 604 represented as F₂(S, E), likewise for other compressed data received by other servers, including the one from server 130, which uses decompression adapter 610 represented as F_{P}(S, E) to generate Y¹(T, E).

The extended approximated system can be represented using equations that relate the system inputs to the generated outputs, which may be represented as follows:

$${Y}^{1} = {X}_{1} {W}_{1} + {X}_{2} {G}_{2} {F}_{2} + {X}_{3} {G}_{3} {F}_{3} + … + {X}_{P} {G}_{P} {F}_{P}$$

$${Y}^{2} = {X}_{1} {G}_{1} {F}_{1} + {X}_{2} {W}_{2} + {X}_{3} {G}_{3} {F}_{3} + … + {X}_{P} {G}_{P} {F}_{P}$$

$${Y}^{3} = {X}_{1} {G}_{1} {F}_{1} + {X}_{2} {G}_{2} {F}_{2} + {X}_{3} {W}_{3} + … + {X}_{P} {G}_{P} {F}_{P}$$

$${Y}^{P} = {X}_{1} {G}_{1} {F}_{1} + {X}_{2} {G}_{2} {F}_{2} + {X}_{3} {G}_{3} {F}_{3} + … + {X}_{P} {W}_{P} .$$

In one or more implementations, the extended approximated system uses approximation function pairs Gᵢ=G(Eᵢ, S) and F₁(S, E) for compute node i. These compression and decompression function pairs can be common across the P−1 other compute nodes j with j≠i, allowing each compute node to apply the same approximation and reconstruction structure while operating on its respective portion of the distributed computation.

FIG. 6C illustrates the compression, decompression, and approximation performed by P processing resources at every compute node for inferencing the ML model 208A. As seen in FIG. 6C, the server 120 compresses the first portion of the set of features X(T, E₁) across P−1 compression adapters using a compression adapter 606 represented as G_{1,2}, a compression adapter 610 represented as G_{1,3}, a compression adapter 612 represented as G_{1,P} and transmits the compressed representation of X(T, E₁) to the server 130 while simultaneously processing the first portion of the set of adjustable weights 302 represented as W(E₁, E) and the first portion of the set of features X(T, E₁) to generate the first portion of the updates for the set of features for the subsequent layer Y₁(T, E). The server 130 decompresses the compressed representation of X(T, Eᵢ) across P−1 decompression adapters using a decompression adapter 608 represented as F_{1,P}, a decompression adapter 614 represented as F_{2,P}, and a decompression adapter 616 represented as F_{P-1,P} to generate approximations of Y (T, E) and subsequently generates Y^{P}(T, E). Similarly, the server 130 compresses the P-th portion of the set of features X(T,E_{P}) across P−1 compression adapters using a compression adapter 602 represented as G_{P,1}, a compression adapter 618 represented as G_{P,2}, and a compression adapter 620 represented as G_{P,P-1} and transmits the compressed representation of X(T, E_{P}) to the server 120 while simultaneously processing the second portion of the set of adjustable weights 304 represented as W (E_{P}, E) and the second portion of the features X(T, E_{P}) to generate the second portion of the updates for the set of features Y_{P}(T,E). The server 120 decompresses the compressed representation of X(T,E_{P}) across P decompression adapters using a decompression adapter 604 represented as F_{2,1}, a decompression adapter 622 represented as F_{3,1}, and a decompression adapter 624 represented as F_{P,1} to generate an approximation of Y_{P}(T, E) and subsequently generate Y¹(T, E).

In one or more implementations, unique pairs of approximation functions G_{i,j} and F_{i,j} can be used for each compute node i with j≠i. This configuration may assign a distinct approximation and reconstruction pathway to each node, allowing the processing flow to account for node-specific feature partitions. The extended approximated system can be represented using equations that relate the system inputs Xi to the corresponding outputs Yi for a single layer, while maintaining compatibility with the distributed execution model and the approximation framework described for multi-node operation. These equations may be represented as follows:

$${Y}^{1} = {X}_{1} {W}_{1} + {X}_{2} {G}_{2 , 1} {F}_{2 , 1} + {X}_{3} {G}_{3 , 1} {F}_{3 , 1} + … + {X}_{P} {G}_{P , 1} {F}_{P , 1}$$

$${Y}^{2} = {X}_{1} {G}_{1 , 2} {F}_{1 , 2} + {X}_{2} {W}_{2} + {X}_{3} {G}_{3 , 2} {F}_{3 , 2} + … + {X}_{P} {G}_{P , 2} {F}_{P , 2}$$

$${Y}^{3} = {X}_{1} {G}_{1 , 3} {F}_{1 , 3} + {X}_{2} {G}_{2 , 3} {F}_{2 , 3} + {X}_{3} {W}_{3} + … + {X}_{P} {G}_{P , 3} {F}_{P \text{.3}}$$

$${Y}^{P} = {X}_{1} {G}_{1 , P} {F}_{1 , P} + {X}_{2} {G}_{2 , P} {F}_{2 , P} + {X}_{3} {G}_{3 , P} {F}_{3 , P} + … + {X}_{P} {W}_{P} .$$

FIGS. 6D-6G illustrate examples of matrix multiplication implementations for different compression and decompression function configurations according to aspects of the subject technology. In one or more implementations, appropriate selections of the functions Gᵢ and Fᵢ can configure the ML model 208A to operate in different modes that align with distributed matrix multiplication structures. Depending on how these functions are defined, the ML model 208A may reduce to a parallel-track block where the functions Gᵢ and Fᵢ are both set to zero (FIG. 6D), a skip block where the functions Gᵢ and Fᵢ are both set to 1 (FIG. 6E), a compression block where the compression function Gᵢ is set to

$${G}_{i}^{′} {W}_{i}$$

(FIG. 6F), or a sharded matrix multiplication implementation where the compression function Gᵢ is set to Wᵢ and the decompression function Fᵢ is set to one (FIG. 6G). In this arrangement, the approximate distributed computation framework can provide a general computational structure from which these behaviors can emerge, allowing a distributed system to adopt different execution modes without altering the underlying data-parallel partitioning strategy. The ability to express multiple matrix multiplication behaviors through the same configurable block may beneficially support architectural unification and simplify coordination among compute nodes during distributed execution.

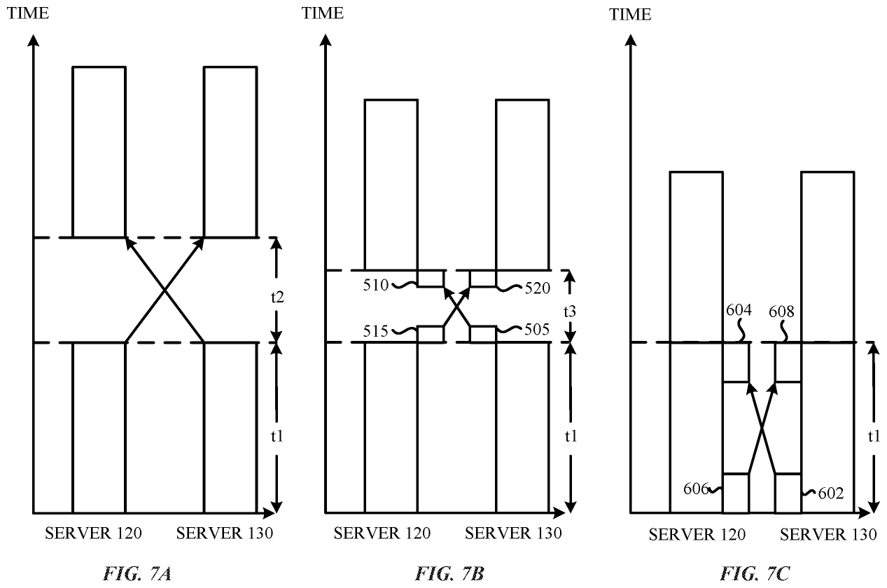

Note that by transmitting the compressed representation of the portions of the set of features and by approximating the portions of updates for the set of features computed by other processing resources, while each of the processing resource is computing their respective portion of the updates, the system 200 may reduce the total time needed to compute the updated set of features for the subsequent layer of the ML model 208A. This is further explained with reference to FIG. 7A-7C.

FIG. 7A is a line chart illustrating the communication overhead between the processing resources described above with reference to FIGS. 4A and 4B. As seen in FIG. 7A, the server 120 performs a matrix multiplication using the first portion of the set of adjustable weights W(E₁, E) and the first portion of the set of features X(T, E₁) to generate Y₁(T, E) in time t1. Similarly, the server 120 performs a matrix multiplication using the second portion of the set of adjustable weights W (E₂, E) and the second portion of the set of features X(T, E₂) to generate Y₂(T, E) in time t1. The server 120 subsequently transmits Y₁(T,E) to the server 130 and the server 130 transmits Y₂(T, E) to the server 120 in time t2, in which after receiving the respective transmissions, the server 120 and the server 130 can perform matrix addition to generate Y(T, E). Thus the total time required for generating the update for a subsequent layer of the ML model 208A is t1+t2.

FIG. 7B is a line chart illustrating the communication overhead between the processing resources described above with reference to FIG. 5. As seen in FIG. 7B, the server 120 performs a matrix multiplication using the first portion of the set of adjustable weights W (E₁, E) and the first portion of the set of features X(T, E₁) to generate Y₁(T, E) in time t1. Similarly, the server 120 performs a matrix multiplication using the second portion of the set of adjustable weights W(E₂, E) and the second portion of the set of features X(T, E₂) to generate Y₂(T, E) in time t1. However, after generating Y₁(T, E), the server 120 uses the compression adapter 515 to compress Y₁(T, E) and transmit the compressed representation of Y₁(T, E) to the server 130. The server 130 after receiving the compressed representation of Y₁(T, E), decompresses the compressed representation of Y₁(T, E) and subsequently generates Y²(T, E) in time t3. Similarly, the server 120 generates Y¹(T, E) in time t3. Thus, the total time required for generating the update for a subsequent layer of the ML model 208A is t1+t3. Since t2>t3, compressing and transmitting Y₁ (T, E) and Y₂(T, E) requires less time, reducing the time needed for performing a forward pass of the ML model 208A. Note that by compressing and transmitting Y₁ (T, E) and Y₂(T, E), the server 120 and the server 130 also minimizes the network bandwidth required for the data transfer.

FIG. 7C is a line chart illustrating the communication overhead between the processing resources described above with reference to FIG. 6. As seen in FIG. 7B, the server 120 compresses the first portion of the set of features X(T, E₁) using the compression adapter 606 and transmits the compressed representation of X(T, E1) to the server 130 while simultaneously processing the first portion of the set of adjustable weights W(E₁, E) and the first portion of the features X(T, E₁) to generate the first portion of the updates for the set of features Y₁(T,E). The server 130 decompresses the compressed representation of X(T, E₁) using the decompression adapter 608 to generate an approximation of Y₁(T, E) and subsequently generates Y²(T, E) in time t1. Similarly, the server 130 compresses the second portion of the set of features X(T, E2) using the compression adapter 602 and transmit the compressed representation of X(T, E₂) to the server 120 while simultaneously processing the second portion of the set of adjustable weights W(E₂, E) and the second portion of the features X(T, E₂) to generate the second portion of the updates for the set of features Y₂(T, E). The server 120 decompresses the compressed representation of X(T, E₂) using the decompression adapter 604 to generate an approximation of Y₂(T, E) and subsequently generate Y¹(T, E) in time t1, requiring the least amount of time for generating the update for a subsequent layer of the ML model 208A.

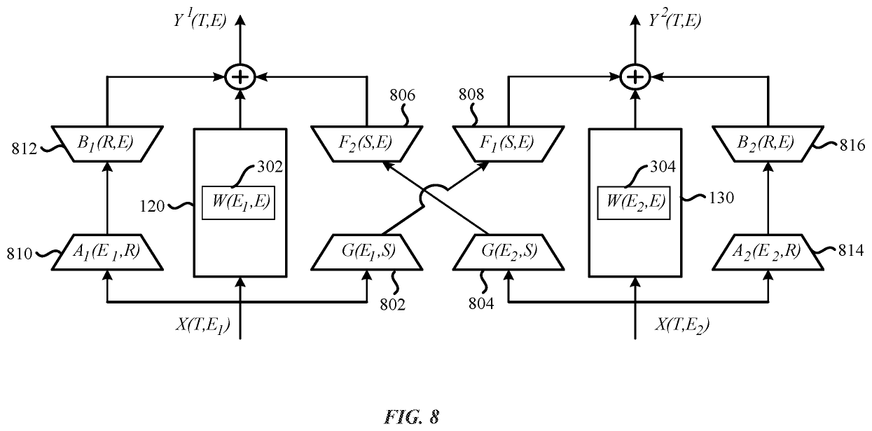

FIG. 8 illustrates the use of Low Rank Adoption (LoRA) adapters for compression and approximation of the different portions of the set of features. In one or more implementations, a low-rank approximation technique may operate as a combined approximation and compression mechanism. The low-rank approximation technique can produce a reduced-dimensional representation of intermediate computations, lowering the amount of data exchanged among distributed compute nodes. This approach may be considered a form of lossy compression because the reduced-rank representation can differ from the full-rank equivalent.

Low-dimensional representations for the functions Gᵢ and Fᵢ may be constructed in a manner analogous to low-rank adaptation methodologies to fine-tune large language models. Selected matrix multiplication layers can incorporate LoRA-style adapters that apply structured, low-rank updates to the underlying weight matrices. Such adapters may modify the output of a matrix multiplication operation through an additive low-rank component while retaining the primary weight matrix in its original form. This configuration can allow the system 200 to adjust layer behavior without retraining or transmitting the full set of weight parameters.

In some implementations, the computing resources can use LoRA adapters to compress and decompress portions of the set of features. The LoRA adapters can be expressed as

$$Y ( T , E ) = X ( T , E ) W ( E , E ) + X ( T , E ) A ( E , R ) B ( R , E ) = X ( T , E ) ( W ( E , E ) + A ( E , R ) B ( R , E ) ) = X ( T , E ) {W}^{′} ( E , E )$$

where W′(E, E)=W(E, E)+A(E, R)B(R, E) and A and B are LoRA approximation functions implemented using LoRA adapters.

As seen in FIG. 8, the server 120 can use LoRA adapters 810 and 812 to train the ML model 208A by adjusting the trainable parameters of the LoRA adapters and freezing the first portion of the set of adjustable weights W(E₁, E) i.e. by not changing the values of the first portion of the set of adjustable weights W(E₁, E) during the training process. For example, during each training iteration, the server 120 can use the LoRA adapters 810 and 812 to implement LoRA functions A1 and B1 to finetune the ML model 208A. While inferencing, the server 120 can processes the first portion of the set of adjustable parameters W(E₁, E) using the first portion of the set of features X(T, E₁) and the LoRA adapters 810 and 812 to generate [symbol] (T, E₁). This can be represented as [symbol] (T, E₁)=X(T, E₁)W(E₁, E)+X(T, E₁)A₁(E₁, R)B₁(R, E). Similarly, the server 130 can generate [symbol] (T, E₂) by processing the second portion of the set of adjustable parameters W(E₂, E) using the second portion of the set of features X(T, E₂) and the LoRA adapters 814 and 816. This can be represented as [symbol] (T, E₂)=X(T, E₂)W(E₂, E)+X(T, E₂)A₂(E₂, R)B₂(R, E). In one or more implementations, the LoRA adapters 810 and 814 are sharded the same as weight matrices W, while the LoRA adapters 812 and 816 are replicated.

In some embodiments, while the server 120 is processing the first portion of the set of weights W(E₁, E) using the first portion of the set of adjustable parameters X(T, E₁), the server 120 can use the LoRA adapter 802 to compress the first portion of the set of features X(T, E₁) and transmit the compressed representation of the first portion of the set of features X(T, E₁) to the server 130. Similarly, the server 130 can use a LoRA adapter 804 to compress the second portion of the set of features X(T, E₂) and transmit the compressed representation of the second portion of the set of features X(T, E₂) to the server 120.

In some embodiments, while the server 120 is generating [symbol] (T, E1), the server 120 can receive the compressed representation of the second portion of the set of features X(T, E₂). Subsequently, the server 120 can use the LoRA adapter 806 to decompress and approximate [symbol] (T, E₂). The server 120 can generate Y¹(T, E) by adding the [symbol] (T, E₁) and the approximated [symbol] (T, E₂). Similarly, the server 130 can receive the compressed representation of the second portion of the set of features X(T, E₁). Subsequently, the server 130 can use the LoRA adapter 808 to decompress and approximate Ŷ(T, E₁). The server 130 can then generate Y²(T, E) by adding the Ŷ(T, E₂) and the approximated Ŷ(T, E1). Note that the operations of compression and decompression performed by the LoRA adapter 802 and the LoRA adapter 808 includes approximation of [symbol] (T, E1). Similarly, the operations of compression and decompression performed by the compression adapter 804 and decompression adapter 806 includes approximation of [symbol] (T, E₂). Though the description of the LoRA adapters 802 and 808 is explained with reference to compression, decompression, and approximation, it should be understood that the LoRA adapters 802 and 808 can be used only for approximating [symbol] (T, E₁) from X(T, E₁). Similarly, the LoRA adapters 804 and 806 can be used only for approximating [symbol] (T, E₂) from X(T, E₂).

In some embodiments, the LoRA adapter 802 and the LoRA adapter 808 can be jointly trained for compression, approximation, and decompression. Similarly, the LoRA adapter 804 and the LoRA adapter 806 can also be jointly trained for compression, approximation, and decompression. For example, training the LoRA adapter 802 and the LoRA adapter 808 can include freezing the first portion of the set of weights and the second portion of the set of weights during a training iteration and updating only the adjustable parameters of the LoRA adapter 802 and the LoRA adapter 808. In other implementations, the LoRA adapter 802 and the LoRA adapter 808 can be trained along with the first portion of the set of adjustable weights and the second portion of the set of adjustable weights. In such embodiments, the adjustable weights of the LoRA adapters 802 and 808 are updated along with the first portion of the set of adjustable weights and the second portion of the set of adjustable weights. In some embodiments, the training of the LoRA adapters 802, 804, 806 and 808 can be performed along with the training of the ML model 208A. In other embodiments, the training of the LoRA adapters 802, 804, 806 and 808 can be performed independently of the training of the ML model 208A.

As seen in FIG. 8 that by approximating the [symbol] (T, E₁) and [symbol] (T, E₂) from X(T, E₁) and X(T, E₂) respectively, and by transmitting X(T, E₁) and X(T, E₂) between the server 120 and the server 130 while the server 120 and server 130 are generating their respective outputs, the system 200 may reduce the communication overhead, reducing the training and/or inferencing time for the ML model 208A.

Though the embodiments described in this specification are explained using two processing resources (e.g., the server 120 and the server 130,) the system 200 can use any number of processing resources. For example, if there are N processing resources, the set of adjustable weights of the ML model 208A can be distributed across N resources. In such embodiments, each processing resource compresses its portion of the set of features and transmits the compressed portion of the set of features to each of the other N−1 processing resources. In such embodiments, each processing resources can receive N−1 compressed representations. Each processing resource can decompress each of the N−1 compressed representations to approximate the updated set of features for the subsequent layer of the ML model 208A, and avoiding any communication overhead between the N processing resources.

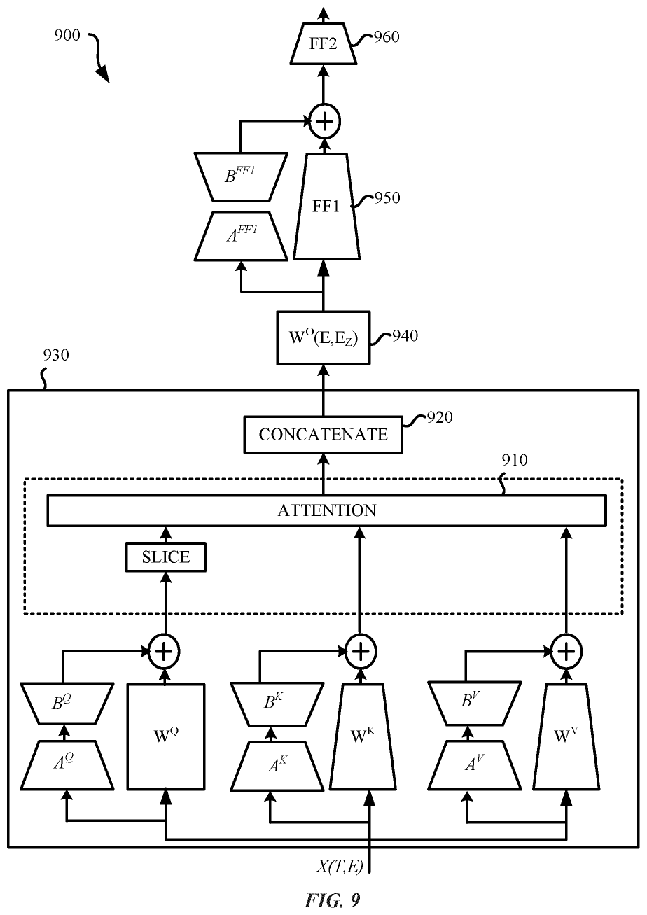

FIG. 9 illustrates an example of a transformer-based ML model 900 with data compression and approximation performed by distributed processing resources according to aspects of the subject technology. In some embodiments, the techniques and methods described for inferencing the ML model 208A can also be used to inference transformer based ML models shared across multiple processing resources. For example, assume that the transformer-based ML model 900 has a set of adjustable weights represented using query (Q), key (K) and value (V) matrices. Assume that the K, Q and V matrices are shared by N processing resources such that each of the N computing resources shares a portion of the K, Q and V matrices. Each processing resource can process their portion of set of features X(T, E) using their portion of the K, Q and V matrices to generate a respective portion of attention values. In other words, attention values are a set of values generated by an attention module 910 of the transformer-based ML model 900, which can be represented as an attention matrix and in this example, each processing resource computes a portion of the attention matrix. The attention matrix of the transformer-based ML model 900 can be constructed by concatenating the portions of the output generated by each of the N processing resources using concatenation module 920. This is further explained using the following equation:

$$MultiHead ( Q , K , V ) = concat ( {head}_{1} , {head}_{2} , … {head}_{N} )$$

where head₁, head₂, . . . head_{N} are the N portions of the output generated N processing resources and MultiHead (Q, K, V) is the attention matrix generated by concatenating the N portions of the output. Since each processing resource may require the portions of the attention matrix generated by each of the other N−1 processing resources, the processing resources must share their respective portions of the attention matrix with each of the other N−1 processing resources which may cause communication delays. To mitigate this issue, each processing resource can compress their portion of the set of features prior to transmitting the compressed portion of the set of features to the other N−1 processing resource. The processing resources receiving the compressed portion of the set of features can approximate the portion of the attention matrix generated by processing resources transmitting the compressed portion of the set of features, allowing computation and communication to overlap which may reduce the inference time and the training time of the transformer-based ML model 900. In some embodiments, the transformer-based ML model 900 can further include one or more additional set of adjustable weights associated with one or more feed forward neural network layers to further process the MultiHead (Q, K, V) i.e., the attention matrix. In such embodiments, the one or more additional set of adjustable parameters can be shared among N processing resources. During inference, the system can use the techniques and methods described with reference to FIGS. 5, 6A-6G and 8 to minimize transmission latency by leveraging the computation time to mask the time required for data transfer.

In one or more implementations, when KV head 930 is distributed across the available compute resources, computations can execute in parallel on each compute resource. This parallel execution may beneficially allow each resource to process its assigned portion of the attention pathways without waiting for intermediate data from other nodes. An output matrix multiplication block 940 can be implemented using an approximate distributed computation matrix multiplication block as described with reference to FIGS. 5, 6A-6G and 8, which may reduce or mitigate the communication overhead associated with the collective communication operation that ordinarily follows this stage. By performing the approximation and compressed data exchange in parallel with the local matrix multiplication computation, the distributed system can avoid the additional synchronization step that would otherwise occur after the output matrix multiplication block 940.

In one or more implementations, a first feed-forward network 950 and a second feed-forward network 960 can be sharded along different axes to avoid introducing communication overhead between the two stages. This arrangement may allow each shard to operate independently without requiring synchronization across compute nodes during the transition between the networks. In one or more other implementations, the second feed-forward network 960 can be implemented using an approximate distributed computation matrix multiplication block as described with reference to FIGS. 5, 6A-6G and 8. By applying approximation and compressed data exchange in parallel with the local matrix multiplication, the approximate distributed computation matrix multiplication block may mitigate the communication overhead associated with the collective communication operation that would otherwise occur at this point in the processing pipeline. This configuration can beneficially reduce inter-node data-exchange latency and may improve sustained compute utilization across the distributed system.

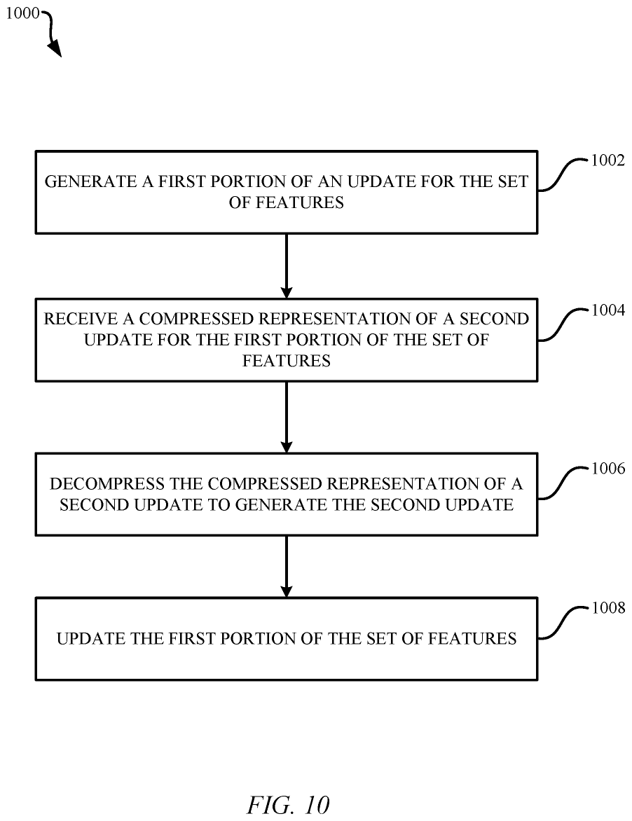

FIG. 10 is a flowchart illustrating an example process 1000 for inferencing a machine learning model. For explanatory purposes, the process 1000 is primarily described herein with reference to the server 120 and the server 130 of FIG. 1. However, the process 1000 is not limited to the server 120 and the server 130 of FIG. 1, and one or more blocks (or operations) of the process 1000 may be performed by one or more other suitable devices. Further for explanatory purposes, the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

At block 1002, the server 120 generates a first portion of an update for the set of features. For example, the server 120 generates the first portion of the set of features X(T, E₁) and the second portion of the set of features X(T, E₂) by sharding the feature matrix along the column dimension. In some embodiments, the server 120 retains the first portion of the set of features X(T, E₁) and transmits the second portion of the set of features X(T, E₂) to the server 130. If the weights W(E₁, E) and the weights W(E₂, E) are associated with any other layer of the ML model 208A, the server 120 can skip the generation of the first portion of the set of features X(T, E₁) and the second portion of the set of features X(T, E₂) and proceed with the subsequent steps.

The server 120 performs a matrix multiplication using the first portion of the set of adjustable weights W (E₁, E) and the first portion of the set of features X(T, E₁) to generate Y₁(T, E) which is the first portion of an update for the set of features. Similarly, the server 130 performs a matrix multiplication using the second portion of the set of adjustable weights W(E₂, E) and the second portion of the set of features X(T, E₂) which is the second portion of an update for the set of features.

At block 1004, the server 120 receives a compressed representation of a second portion of update for the set of features from the server 130. For example, the server 120 compresses the first portion of the set of features X(T, E₁) using an adapter 606 and transmits the compressed representation of X(T, E₁) to the server 130 while simultaneously processing the first portion of the set of adjustable weights W(E₁, E) and the first portion of the set of features X(T, E₁) to generate the first portion of the updates for the set of features Y₁(T, E). Similarly, the server 130 compresses the second portion of the set of features X(T, E₂) using the adapter 602 and transmit the compressed representation of X(T, E₂) to the server 120 while simultaneously processing the second portion of the set of adjustable weights W(E₂, E) and the second portion of the features X(T, E₂) to generate the second portion of the updates for the set of features Y₂(T, E).

At block 1006, the server 120 decompresses the compressed representation of the second portion of update for the set of features. For example, The server 120 decompresses the compressed representation of X(T, E₂) using the adapter 604 to generate an approximation of Y₂(T, E) and subsequently generate Y¹(T, E). Similarly, the server 130 decompresses the compressed representation of X(T, E₁) using the adapter 608 to generate an approximation of Y₁(T, E) and subsequently generates Y²(T, E).

At block 1008, the server 120 updates the first portion of the set of features. For example, the server 120 can decompress the compressed representation of X(T, E₂) using adapter 604 to generate an approximation of Y₂(T, E) and subsequently generate Y¹(T, E) by adding the approximated Y₂(T, E) to Y₁(T, E). Similarly, the server 130 can decompress the compressed representation of X(T, E₁) using adapter 608 to generate an approximation of Y₁ (T, E) and subsequently generate Y²(T, E) by adding the approximated Y₁ (T, E) to Y₂(T, E).

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the training and predicting processes of the first ML model 208A can be used to benefit users.

For example, the data can be used to train models that can be deployed to improve performance, accuracy, and/or functionality of applications and/or services. Accordingly, the use of the data enables the training and predicting processes of the first ML model 208A to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the training and predicting processes of the first ML model 208A are also contemplated by the present disclosure.

The present disclosure contemplates that, in some embodiments, data used by the training and predicting processes of the first ML model 208A include publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with the training and predicting processes of the first ML model 208A, should attempt to comply with well-established privacy policies and/or privacy practices.

FIG. 11 illustrates an electronic system 1100 with which one or more implementations of the subject technology may be implemented. The electronic system 1100 can be, and/or can be a part of, the server 120 and the server 130 shown in FIG. 1. The electronic system 1100 may include various types of computer readable media and interfaces for various other types of computer readable media. The electronic system 1100 includes a bus 1108, one or more processing unit(s) 1112, a system memory 1104 (and/or buffer), a ROM 1110, a permanent storage device 1102, an input device interface 1114, an output device interface 1106, and one or more network interfaces 1116, or subsets and variations thereof.

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a floppy disk, flash drive, and its corresponding disk drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random-access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input and output device interfaces 1114 and 1106. The input device interface 1114 enables a user to communicate information and select commands to the electronic system 1100. Input devices that may be used with the input device interface 1114 may include, for example, alphanumeric keyboards and pointing devices (also called “cursor control devices”). The output device interface 1106 may enable, for example, the display of images generated by electronic system 1100. Output devices that may be used with the output device interface 1106 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to one or more networks and/or to one or more network nodes through the one or more network interface(s) 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
inferencing a machine learning model comprising a set of adjustable weights, wherein the inference comprises multiple iterations of processing input data, each iteration comprising:
processing, by a first processing resource, a first portion of the set of adjustable weights and a first portion of a set of features to generate a first portion of an update for the set of features, wherein the first portion of the set of features is derived from a first portion of the input data;
while generating the first portion of the update for the set of features:
receiving, by the first processing resource and from a second processing resource, an approximated and compressed representation of a second portion of the update for the set of features, wherein the compressed representation of the second portion of the update for the set of features is derived from a second portion of the input data;
decompressing, by the first processing resource, the compressed representation of the second portion of the update for the set of features; and
updating the first portion of the set of features, by the first processing resource, based at least in part on the first portion of the update for the set of features and the decompressed second portion of the update for the set of features.

2. The method of claim 1, further comprising:
approximating and compressing, by the first processing resource, the first portion of the set of features; and
transmitting, by the first processing resource, the approximated and compressed first portion of the set of features to the second processing resource.

3. The method of claim 1, wherein processing the first portion of the set of adjustable weights and the first portion of the set of features comprises:
representing the first portion of the set of adjustable weights as a first matrix;
representing the first portion of the set of features as a second matrix; and
multiplying the first matrix and the second matrix to generate the first portion of the update for the set of features.

4. The method of claim 1, wherein decompressing the compressed representation of the second portion of the update for the set of features comprises:
decompressing, the compressed representation of the second portion of the update for the set of features using a first function that is trained jointly with a second function, wherein the compressed representation of the second portion of the update for the set of features is generated by compressing a second portion of the set of features using the second function by the second processing resource.

5. The method of claim 4, wherein the first function and the second function comprises Low-Rank Adaptation Functions.

6. The method of claim 1, wherein the first portion of the set of adjustable weights are stored in the first processing resource and the second portion of the set of adjustable weights are stored in the second processing resource.

7. The method of claim 1, wherein the machine learning model is a neural network.

8. The method of claim 7, wherein inferencing the neural network comprises performing a forward pass on the neural network.

9. A system comprising:
a processor; and
a memory device containing instructions which, when executed by the processor, cause an application process to:
infer a machine learning model comprising a set of adjustable weights, wherein the inference comprises multiple iterations of processing input data, wherein each iteration comprises:
process a first portion of the set of adjustable weights and a first portion of a set of features to generate a first portion of an update for the set of features, wherein the first portion of the set of features is derived from a first portion of the input data;
while generating the first portion of the update for the set of features:
receive, from another system, an approximated and compressed representation of a second portion of the update for the set of features, wherein the compressed representation of the second portion of the update for the set of features is derived from a second portion of the input data;
decompress the compressed representation of the second portion of the update for the set of features; and
update the first portion of the set of features based at least in part on the first portion of the update for the set of features and the decompressed second portion of the update for the set of features.

10. The system of claim 9, further comprises:
approximating and compressing the first portion of the set of features; and
transmitting the compressed first portion of the set of features to the other system.

11. The system of claim 9, wherein processing the first portion of the set of adjustable weights and the first portion of the set of features comprises:
representing the first portion of the set of adjustable weights as a first matrix;
representing the first portion of the set of features as a second matrix; and
multiplying the first matrix and the second matrix to generate the first portion of the update for the set of features.

12. The system of claim 9, wherein decompressing the compressed representation of the second portion of the update for the set of features comprises:
decompressing, the compressed representation of the second portion of the update for the set of features using a first function that is trained jointly with a second function, wherein the compressed representation of the second portion of the update for the set of features is generated by compressing a second portion of the set of features using the second function by the other system.

13. The system of claim 12, wherein the first function and the second function comprises Low-Rank Adaptation Functions.

14. The system of claim 9, wherein the machine learning model is a neural network.

15. The system of claim 14, wherein inferencing the neural network comprises performing a forward pass on the neural network.

16. A non-transitory machine-readable medium comprising instructions that, when executed by one or more processors, cause the one or more processors to perform operations comprising:
inferencing a machine learning model comprising a set of adjustable weights, wherein the inference comprises multiple iterations of processing input data, each iteration comprising:
processing, by a first processing resource, a first portion of the set of adjustable weights and a first portion of a set of features to generate a first portion of an update for the set of features, wherein the first portion of the set of features is derived from a first portion of the input data;
while generating the first portion of the update for the set of features:
receiving, by the first processing resource and from a second processing resource, an approximated and compressed representation of a second portion of the update for the set of features, wherein the compressed representation of the second portion of the update for the set of features is derived from a second portion of the input data;
decompressing, by the first processing resource, the compressed representation of the second portion of the update for the set of features; and
updating the first portion of the set of features, by the first processing resource, based at least in part on the first portion of the update for the set of features and the decompressed second portion of the update for the set of features.

17. The non-transitory machine-readable medium of claim 16, wherein the operations further comprises:
approximating and compressing, by the first processing resource, the first portion of the set of features; and
transmitting, by the first processing resource, the compressed first portion of the set of features to the second processing resource.

18. The non-transitory machine-readable medium of claim 17, wherein the operations of processing the first portion of the set of adjustable weights and the first portion of the set of features comprises:
representing the first portion of the set of adjustable weights as a first matrix;
representing the first portion of the set of features as a second matrix; and
multiplying the first matrix and the second matrix to generate the first portion of the update for the set of features.

19. The non-transitory machine-readable medium of claim 17, wherein the operations of decompressing the compressed representation of the second portion of the update for the set of features comprises:
decompressing, the compressed representation of the second portion of the update for the set of features using a first function that is trained jointly with a second function, wherein the compressed representation of the second portion of the update for the set of features is generated by compressing a second portion of the set of features using the second function by the second processing resource.

20. A method comprising:
training a machine learning model comprising a set of adjustable weights, wherein the training comprises multiple iterations of processing training data, each iteration comprising:
processing, by a first processing resource, a first portion of the set of adjustable weights and a first portion of a set of features to generate a first portion of an update for the set of features, wherein the first portion of the set of features is derived from a first portion of the training data;
while generating the first portion of the update for the set of features:
receiving, by the first processing resource and from a second processing resource, an approximated and compressed representation of a second portion of the update for the set of features, wherein the compressed representation of the second portion of the update for the set of features is derived from a second portion of the training data;
decompressing, by the first processing resource, the compressed representation of the second portion of the update for the set of features; and
updating the first portion of the set of features, by the first processing resource, based at least in part on the first portion of the update for the set of features and the decompressed second portion of the update for the set of features.
